(19) United States
(12) Patent Application Publication
(10) Pub. No.: US 2009/0253847 A1
(43) Pub. Date: Oct. 8, 2009

(54) RESIN COMPOSITION AND USE OF THE SAME

(75) Inventors: Shintaro KOMATSU, Tsukuba-Shi (JP); Mitsuo MAEDA, Tsukuba-Shi (JP); Hiroshi HARADA, Tsukuba-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/414,839

(22) Filed: Mar. 31, 2009

(30) Foreign Application Priority Data
Apr. 4, 2008 (JP) 2008-098007

(51) Int. Cl. C08K 3/22

(52) U.S. Cl. 524/430

(57) ABSTRACT

The present invention provides a resin composition comprising (A) a thermoplastic resin, (B) alumina fine particles and (C) a plate-like filler, wherein the component (B) is contained in the larger amount than the amount of the component (C) in the composition, and the resin composition has a specific volume resistance of 1×10¹⁰ Ωm or more.

### BACKGROUND OF THE INVENTION

1. Field of the Invention

The present invention relates to a resin composition which gives a molded article having excellent thermal conductivity, and a molded article obtainable by molding the resin composition.

2. Description of the Related Art

There have recently been concerned about heat generation in electric and electronic components with the progress of miniaturization and high performances in the electric and electronic fields. When heat radiation control is insufficient against the heat generation, heat accumulation may cause deterioration of performances of electric and electronic components. Thus, it is considered to be important to impart high thermal conductivity to members to be used for electric and electronic components.

Heretofore, metallic materials have been used mainly for components requiring high thermal conductivity. However, the metallic materials are insufficient in light-weight properties and processability in view of conformity with miniaturization of the components. Thus, the metallic materials have been replaced by resin materials.

However, resin materials usually have low thermal conductivity and it is difficult to convert the resin materials themselves into resin materials having high thermal conductivity. Therefore, there has been studied a method in which resin materials are converted into resin materials having high thermal conductivity by mixing with a large amount of fillers made of materials having high thermal conductivity (e.g., copper, aluminum, aluminum oxide, etc.) (for example, refer to Japanese Unexamined Patent Publication No. 62-100577, Japanese Unexamined Patent Publication No. 4-178421 and Japanese Unexamined patent Publication No. 5-86246).

Usually, a molded article having comparatively complicated shapes used in electric and electronic components is produced by melt molding. However, when using the resin compositions disclosed in the Patent Documents described above, there is a tendency that the resulting molded articles may have anisotropy of thermal conductivity. When these molded articles are applied to the electric and electronic components, heat radiation of the components may be easily insufficient. Depending on the material of the filler to be applied, electrical conductivity may be imparted to the molded articles, and thus making it difficult to apply the molded articles to insulating members of electric and electronic components.

### SUMMARY OF THE INVENTION

One of objects of the present invention is to provide a resin composition which can be made into a molded article having satisfactory thermal conductivity while maintaining electrical insulating properties, which is suited for providing electric and electronic components, and also having small anisotropy of thermal conductivity, and to provide such a molded article.

The present inventors have intensively studied on resin compositions, and thus the present invention has been completed.

The present invention provides a resin composition comprising:
(A) a thermoplastic resin,
(B) alumina fine particles and
(C) a plate-like filler comprising an electrical insulating material,
   wherein the resin composition contains the component (B) in the larger amount than the amount of the component (C) and has a specific volume resistance of 1×10¹⁰ Ωm or more.

Further, the present invention provides a molded article obtainable by using the resin composition, and also provides electric and electronic components prepared from the molded article.

Using the resin composition of the present invention, there can be obtained a molded article which exhibits satisfactory thermal conductivity while having electrical insulating properties suited as electric and electronic components, and also has small anisotropy of thermal conductivity. Such a molded article is suited for electric and electronic components, particularly electric and electronic components requiring electrical insulating properties and is therefore highly industrially useful.

### BRIEF DESCRIPTION OF THE DRAWINGS

FIG. 1 is a schematic diagram showing an outline of a bimodal particle size distribution.

FIG. 2 is a schematic diagram showing an outline of a bimodal particle size distribution with shoulder peaks.

FIG. 3 is a perspective view schematically showing an aspect ratio (D/T) of one plate-like filler.

### DETAILED DESCRIPTION OF THE PREFERRED EMBODIMENTS

Preferred embodiments of the present invention are described in detail below.

A resin composition of the present invention comprises:
(A) a thermoplastic resin,
(B) alumina fine particles and
(C) a plate-like filler comprising an electrical insulating material.
   The resin composition has electrical insulating properties and has a specific volume resistance of 1×10¹⁰ Ωm or more.

The specific volume resistance of the resin composition corresponds to the specific volume resistance of the molded article obtained from the resin composition, which is measured at a temperature of about 23° C.

### <Alumina Fine Particles as Component (B)>

First, alumina fine particles as the component (B) are described.

The alumina fine particles as the component (B) are preferably fine particles including α alumina, and particularly preferably fine particles having an aluminum oxide (Al₂O₃) content of 95% by weight or more and a volume-average particle diameter of 0.1 to 50 μm. A higher content of alumina oxide is more advantageous in view of electrical insulation and thermal conductivity, and the content is preferably 99% by weight or more, and more preferably 99.5% by weight or more. The volume-average particle diameter of the alumina fine particles is preferably from 0.1 to 30 μm, more preferably from 0.1 to 20 μm, and particularly preferably from 0.1 to 10 μm. The volume-average particle diameter of the alumina fine particles is measured by Microtrac particle size analyzer (using HRA manufactured by Nikkiso Co., Ltd. in the present invention) with the following procedure. Alumina fine particles are added to an aqueous 2 wt % sodium hexametaphosphate solution and, after sufficiently dispersing using an ultrasonic cleaning equipment, the mixture was irradiated with a laser beam, followed by the measurement of diffraction (scatter) (the measurement of the particle size distribution by laser diffraction scattering).

The alumina fine particles may have any of spherical, polyhedral and ground particulate forms as long as the above aluminum oxide content is satisfied. However, as the component (B), alumina fine particles having a BET specific surface area of 1.0 to 5 m²/g are preferred. It is particularly preferred that the alumina particles have a ground particulate form since the form easily gives a relatively larger specific surface area. It is advantageous that the BET specific surface area of the alumina fine particles is within a range from 1.0 to 5 m²/g by the following reason. When the resin composition of the present invention is formed into a molded article through melt molding, it does not considerably damage a mold used for molding, and the resulting molded article is more excellent in thermal conductivity. Since the damage of the mold can be decreased and a molded article with higher thermal conductivity is obtained, the BET specific surface area of the alumina fine particles is preferably within a range from 1 to 3 m²/g, and more particularly from 1.0 to 2.5 m²/g. In order to obtain such alumina fine particles, alumina fine particles having a BET specific surface area of 1 to 5 m²/g may be selected from commercially available alumina fine particles described later. Alternatively, alumina fine particles may also be produced by preparing alumina fine particles having a proper volume-average particle diameter (e.g., volume-average particle diameter of about 40 to 70 μm), grinding the alumina fine particles by various known means to increase the specific surface area so as to adjust the BET specific surface area within the above range. The grinding means includes a method using a grinder such as a jet mill, micron mill, ball mill, vibration mill or media mill.

In the present invention, a nitrogen adsorption method shown below is employed as the method for measuring the BET specific surface area of the alumina fine particles. First, the alumina fine particles are subjected to vacuum deaeration treatment at 120° C. for 8 hours, and then adsorption isotherm of nitrogen is measured by a constant volume method. Using the adsorption isotherm, a specific surface area is calculated by the BET single point method. In the present invention, BEL SORP-mini manufactured by BEL Japan, Inc. is used.

It is also possible to use easily available alumina fine particles (commercially available alumina fine particles). Examples of the commercially available alumina fine particles include such as alumina fine particles manufactured by Sumitomo Chemical Co., Ltd., alumina fine particles manufactured by Showa Denko K.K., and alumina fine particles manufactured by Nippon Light Metal Co., Ltd. It is possible to select alumina fine particles having a BET specific surface area of 1 to 5 m²/g, preferably alumina fine particles having a BET specific surface area of 1 to 3 m²/g and a volume-average particle diameter of 0.1 to 5 μm, among these commercially available alumina fine particles.

It is preferred that the alumina fine particles as the component (B) exhibit a bimodal particle size distribution when measured by laser diffraction scattering, and it is more preferred that the alumina fine particles exhibit a bimodal particle size distribution having a maximum value within a range from 1 to 5 μm in terms of a volume-average particle diameter and a maximum value within a range from 0.1 to 1 μm in terms of a volume-average particle diameter so as to satisfy the above preferable volume-average particle diameter. When the alumina fine particles having such a bimodal particle size distribution are used as the component (B), a large amount of the alumina fine particles can be contained in the resulting molded article obtained from the resin composition. Thus obtained molded article achieve more excellent thermal conductivity.

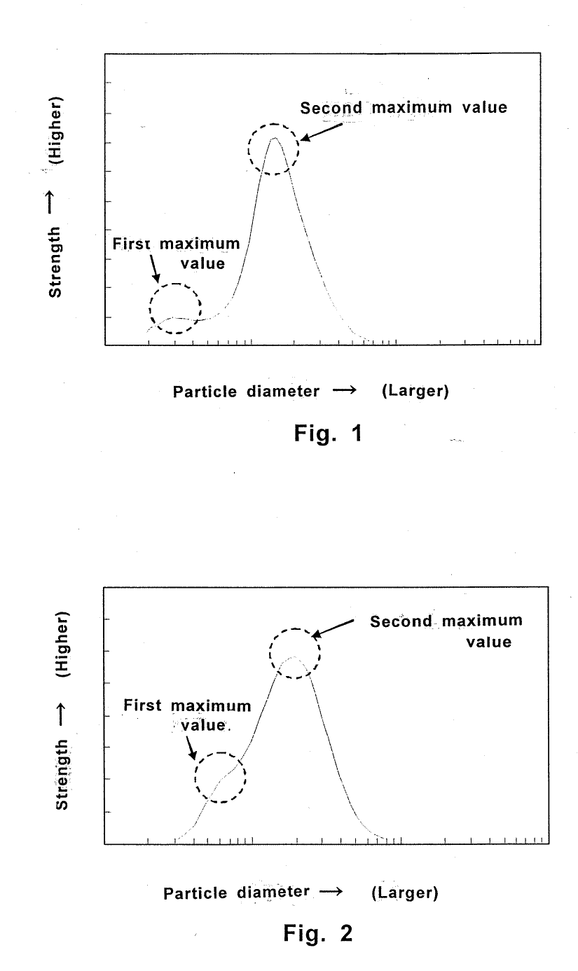

Herein, “bimodality” is briefly described with reference to the drawings. FIG. 1 and FIG. 2 are schematic diagrams showing an outline of the particle size distribution of bimodal alumina fine particles obtained by laser diffraction scattering. In the schematic drawings, the horizontal axis denotes the particle size, while the vertical axis denotes the strength at a given particle size, and the particle size increases rightward along the horizontal axis. FIG. 1 shows a typical bimodal particle size distribution, and there exists two maximum values (a first maximum value and a second maximum value) in the particle size distribution. Further, in the case where the first maximum value appears as if it is a shoulder peak of the peak with the second maximum value, as shown in FIG. 2, the particle size distribution is defined as bimodal. In the bimodal particle size distribution, the alumina fine particles having the first maximum value within a range from 0.1 to 1 μm and the second maximum value within a range from 1 to 5 μm are particularly preferred as the component (B) used in the present invention.

### <Plate-Like Filler as Component (C)>

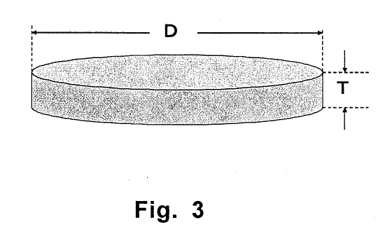

The component (C) is a plate-like filler and the plate-like filler means a filler having an aspect ratio of 5 or more. The aspect ratio is as described in Filler Handbook, pp. 10-16 and pp. 23-30, edited by the Filler Society of Japan, in which the aspect ratio is the value calculated by a ratio (D/T) of the average diameter (D) to the average thickness (T) in the plane portion of one plate-like filler. In the present invention, the aspect ratio means the value measured by, for example, averaging respective D/Ts of 100 or more plate-like fillers. FIG. 3 is a perspective view schematically showing one plate-like filler. The mean diameter (D) and thickness (T) in the plane portion of the plate-like filler are shown in the drawings (provided that the dimensions in FIG. 3 are arbitrary in view of easiness in seeing). The plate-like filler having an aspect ratio of 15 or more is particularly preferred as the component (C) of the present invention.

The plate-like filler as the component (C) comprises an electrical insulating material, and may be selected from fillers made of electrical insulating materials, to maintain electrical insulating properties of the resulting resin composition as well as the molded article obtained therefrom.

The volume-average particle diameter measured by a laser diffraction method of the plate-like filler used as the component (C) is preferably in the range of from 15 μm or more, more preferably in the range of from 15 to 50 μm, and most preferably in the range of from 15 to 30 μm. When the volume-average particle diameter is too small, the mixing of the plate-like filler as the component (C) with a thermoplastic resin as the component (A) may be difficult. In such a case, the production of the thermoplastic resin composition itself tends to be difficult, and also the plate-like fillers tends to unevenly exist in the resulting molded article, which may resulting in deterioration of the thermal conductivity of the article. In contrast, when the volume-average particle diameter is too large, mechanical properties of the resulting molded article may deteriorate. The volume-average particle diameter of the plate-like filler as used herein is measured by Microtrac particle size analyzer (SRA manufactured by Nikkiso Co., Ltd. was used in the present invention). Specifically, the average diameter is obtained by adding the plate-like filler to ethanol, dispersing the mixture by an ultrasonic cleaning equipment, irradiating the mixture with a laser beam, and measuring the diffraction (scatter).

The plate-like filler (C) is a filler having the above-described aspect ratio and comprising an electrical insulating material. Examples of the plate-like filler (C) include mica such as kaolinite, talc, celisite, moscobite and phlogopite; layered clay minerals such as chlorite, montmorillonite and halloysite; glass flakes: and the like. In view of the electrical insulating properties and thermal conductivity of the plate-like filler itself, talc is preferred as the component (C). Talc is also advantageous in terms of the low price.

Talc is generally obtained by coarsely grinding a mineral ore produced naturally, followed by finely grinding and further classification. Examples of the device used for coarse grinding include such as a joke crusher, hammer crusher and roll crusher. Examples of the device used for fine grinding include such as a jet mill, screen mill, roller mill and vibration mill. Examples of the device used for classification include such as a cyclone air separator, micro separator and sharp cut separator.

The BET specific surface area of the plate-like filler of the component (C) is preferably in the range of from 1 to 5 m²/g, more preferably from 1.5 to 4 m²/g, and particularly preferably from 2 to 3 m²/g. When the BET specific surface area of the plate-like filler to be used is within the above range, it becomes easy to mix the plate-like filler with the thermoplastic resin as the component (A), and thus tends to more easily produce the resin composition of the present invention. In such a case, there is further exerted the effect of decreasing anisotropy of thermal conductivity of the resulting molded article. The BET specific surface area of the plate-like filler may be measured by the same manner as in the case of the alumina fine particles. As described above, talc is preferred as the plate-like filler. The talc having a BET specific surface area of from 1 to 5 m²/g is particularly preferred as the component (C).

As the talc exhibiting a preferred BET specific surface area, for example, talc having a BET specific surface area of 1 to 5 m²/g, preferably a BET specific surface area of 1.5 to 4 m²/g, and a volume-average particle diameter of 15 to 50 μm may be selected from among commercially available talc such as talc manufactured by Nippon Talc Co., Ltd. or talc manufactured by Asada Milling Co., Ltd. These commercially available talcs have an aspect ratio of 5 or more.

The above commercially available talc may be used as it is, or the surface of the talc may be subjected to a surface treatment using a coupling agent (e.g., silane coupling agent, titanium coupling agent, etc.) or a surfactant so as to enhance dispersibility in the thermoplastic resin as the component (A) and adhesiveness with the thermoplastic resin as the component (A).

Examples of the silane coupling agent used for the surface treatment include such as methacrylsilane, vinylsilane, epoxysilane and aminosilane, and examples of the titanium coupling agent include titanic acid. Examples of the surfactant include such as a higher fatty acid, higher fatty acid ester, higher fatty acid amide and higher fatty acid salts.

### <Thermoplastic Resin as Component (A)>

The thermoplastic resin as the component (A) which can be used in the present invention is described below.

The thermoplastic resin is preferably a thermoplastic resin which can be molded at a molding temperature of 200 to 450° C., and examples thereof include such as polyolefins, polystyrenes, polyamides, halogenated vinyl resins, polyacetals, saturated polyesters, polycarbonates, polyarylsulfones, polyarylketones, polyphenyleneethers, polyphenylene sulfides, polyaryl ether ketones, polyethersulfones, polyphenylenesulfide sulfones, polyarylates, polyamides, liquid crystalline polyesters and fluorine resins. The thermoplastic resin selected from the group can be used alone, or used as a polymer alloy of a combination of two or more kinds of them.

Among these thermoplastic resins, liquid crystalline polyester, polyether sulfone, polyarylate, polyphenylene sulfide, polyamide 4/6 and polyamide 6T are preferably used in view of heat resistance and electrical insulating properties. Further, polyphenylene sulfide and liquid crystalline polyester are more preferred, and liquid crystalline polyester is most preferred in view of heat resistance, electrical insulating properties and thin-wall fluidity. Thus, liquid crystalline polyester having excellent thin-wall fluidity is preferably used as the component (A) since moldability is particularly improved when electric and electronic components having comparatively complicated shape are molded.

Polyphenylene sulfide and liquid crystalline polyester as a preferred component (A) is described below.

The polyphenylene sulfide is typically a resin which mainly contains a structural unit represented by the following formula (10). Examples of the method for producing the polyphenylene sulfide include the reaction of a halogen-substituted aromatic compound with an alkali sulfide disclosed in U.S. Pat. No. 2,513,188 and Japanese Examined Patent publication No. 44-27671, the condensation reaction of thiophenols in the presence of such as an alkaline catalyst or a copper salt disclosed in U.S. Pat. No. 3,274,165 and the condensation reaction of an aromatic compound with sulfur chloride in the presence of a Lewis acid catalyst described in Japanese Examined Patent Publication No. 46-27255. It is also possible to use commercially available polyphenylene sulfide (e.g., polyphenylene sulfide available from DIC Corporation).

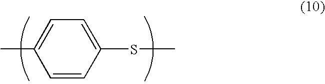

Next, the liquid crystalline polyester is described below.

As described above, since the liquid crystalline polyester has excellent thin-wall fluidity, it is advantageous that a molded article having a comparatively complicated shape is easily obtained. In contrast, the liquid crystalline polyester tends to have properties that the polymer molecules are comparatively oriented, so that the fillers having high thermal conductivity are likely to be oriented easily along the alignment direction of the polymer molecules, resulting in an increase in anisotropy of thermal conductivity. According to the present invention, the anisotropy of thermal conductivity can be decreased even if the liquid crystalline polyester is used in the thermoplastic resin as the component (A) while sufficiently maintaining properties of the liquid crystalline polyester such as mechanical properties.

The liquid crystalline polyester means a polyester referred to as a thermotropic liquid crystal polymer, which can form a melt exhibiting optical anisotropy at a temperature of 450° C. or lower. Specific examples of the liquid crystalline polyester include such as:
(1) a substance obtained by polymerizing a combination of an aromatic hydroxycarboxylic acid, aromatic dicarboxylic acid and aromatic diol;
(2) a substance obtained by polymerizing a plurality of aromatic hydroxycarboxylic acids;
(3) a substance obtained by polymerizing a combination of an aromatic dicarboxylic acid and aromatic diol; and
(4) a substance obtained by reacting a crystalline polyester, such as polyethylene terephthalate, with an aromatic hydroxycarboxylic acid.

It is also possible to use ester-forming derivatives of the aromatic hydroxyl carboxylic acid, aromatic dicarboxylic acid and aromatic diol, instead of using the aromatic hydroxylcarboxylic acid, aromatic dicarboxylic acid or aromatic diol. When using the ester-forming derivatives, the resulting liquid crystal polyester can be easily produced.

Examples of the ester-forming derivatives include the followings. In the case of the ester-forming derivatives of an aromatic hydroxycarboxylic acid and aromatic dicarboxylic acid, which have a carboxyl group in the molecules, examples thereof include those in which the carboxyl group is converted into a group such as a highly reactive acid halogen group or an acid anhydride group, and those in which the carboxyl group forms esters together with alcohols or ethylene glycol. In the case of the ester-forming derivatives of an aromatic hydroxycarboxylic acid and aromatic diol, which have a phenolic hydroxyl group in the molecules, examples thereof include those in which the phenolic hydroxyl group forms esters with lower carboxylic acids.

The aromatic hydroxycarboxylic acid, aromatic dicarboxylic acid or aromatic diol may have a substituent on the aromatic ring, such as a halogen atom including a chlorine and fluorine atom; an alkyl group having 1 to 10 carbon atoms including a methyl, ethyl and butyl group; and an aryl group having 6 to 20 carbon atoms including a phenyl group, as long as the substituent does not inhibit the ester-forming properties.

Examples of the structural unit of the liquid crystalline polyester include the followings.

Structural units derived from an aromatic hydroxycarboxylic acid:

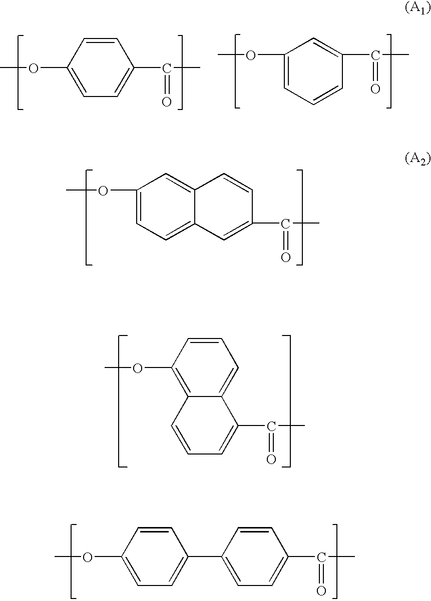

These structural units may have a halogen atom, alkyl group or aryl group as a substituent.

Structural units derived from an aromatic dicarboxylic acid:

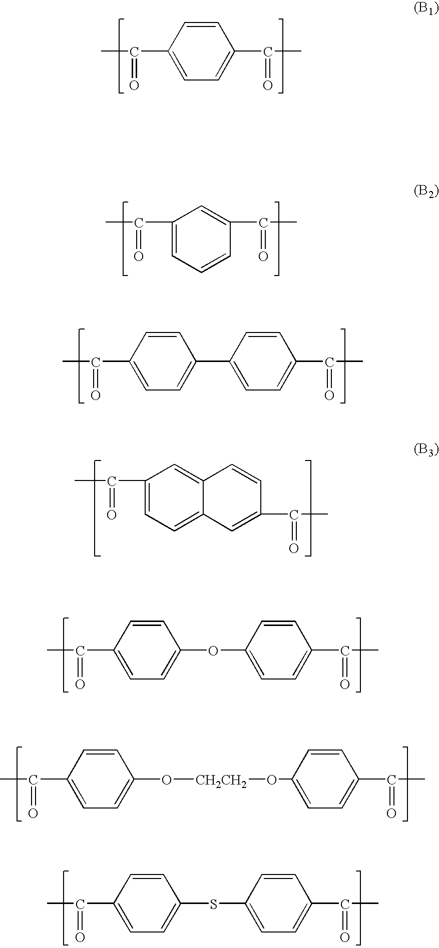

These structural units may have a halogen atom, alkyl group or aryl group as a substituent.

Structural units derived from an aromatic diol:

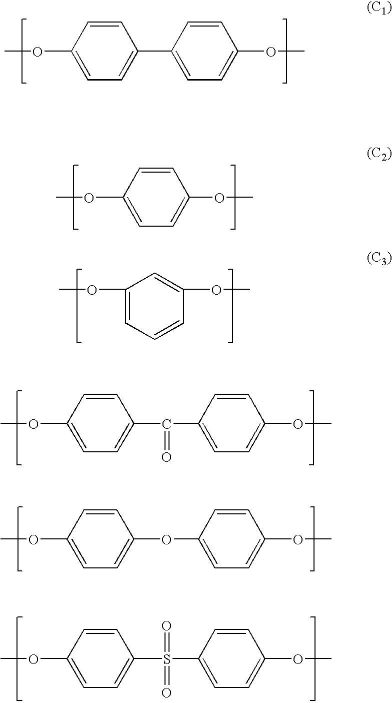

These structural units may have a halogen atom, alkyl group or aryl group as a substituent.

Particularly preferred liquid crystalline polyester is described below.

It is preferred that the structural unit derived from the aromatic hydroxycarboxylic acid has a structural unit ((A₁)) derived from parahydroxybenzoic acid and/or a structural unit ((A₂)) derived from 2-hydroxy-6-naphthoic acid,
the structural unit derived from the aromatic dicarboxylic acid preferably has a structural unit selected from the group consisting of a structural unit ((B₁)) derived from terephthalic acid, ((B₂)) derived from isphthalic acid and ((B₃)) derived from 2,6-naphthalenedicarboxylic acid, and
the structural unit derived from the aromatic diol preferably has a structural unit ((C₂)) derived from hydroquinone and/or a structural unit ((C₁)) derived from 4,4′-dihydroxybiphenyl. As the combination thereof, those shown below by (a) to (h) are preferred.

(a): A combination of (A₁), (B₁) and (C₁), or a combination of (A₁), (B₁), (B₂) and (C₁).

(b): A combination of (A₂), (B₃) and (C₂), or a combination of (A₂), (B₁), (B₃) and (C₂).

(c): A combination of (A₁) and (A₂).

(d): A combination of the structural units represented by (a), in which a part or all of (A₁) is replaced with (A₂).

(e): A combination of the structural units represented by (a), in which a part or all of (B₁) is replaced with (B₃).

(f): A combination of the structural units represented by (a), in which a part or all of (C₁) is replaced with (C₃).

(g): A combination of the structural units represented by (b), in which a part or all of (A₂) is replaced with (A₁).

(h): A combination of the structural units represented by (c), added with (B₁) and (C₂).

The liquid crystalline polyesters having the units in the combinations (a) to (h) are preferred since such liquid crystalline polyesters are advantageous in electrical insulating properties.

The method for producing liquid crystalline polyesters (a) and (b) are described, for example, in Japanese Examined Patent Publication No. 47-47870 and Japanese Examined Patent Publication No. 63-3888.

Examples of the particularly preferred liquid crystalline polyester include a polyester having the structural unit derived from the aromatic hydroxycarboxylic acid, such as a structural unit ((A₁)) derived from parahydroxybenzoic acid and/or a structural unit ((A₂)) derived from 2-hydroxy-6-naphthoic acid, in an amount of 30 to 80% by mol in total,
a structural unit derived from the aromatic diol, including the structural unit ((C₂)) derived from hydroquinone and/or the structural unit ((C₁)) derived from 4,4′-dihydroxybiphenyl, in an amount of 10 to 35% by mol in total, and
a structural unit derived from the aromatic dicarboxylic acid, including the structural unit selected from the group consisting of the structural unit ((B₁)) derived from terephthalic acid, the structural unit ((B₂)) derived from isophthalic acid and the structural unit ((B₃)) derived from 2,6-naphthalenedicarboxylic acid, in an amount of 10 to 35% by mol in total, based on the total amount of the entire structural units.

As the method for producing the liquid crystalline polyester, a known method described in Japanese Unexamined Patent Publication No. 2002-146003 or the like is employed. Specifically, a method can be exemplified in which the above material monomer (aromatic hydroxycarboxylic acid, aromatic dicarboxylic acid, aromatic diol or ester-forming derivatives thereof) is subjected to melt polymerization to obtain an aromatic polyester having comparatively low molecular weight (hereinafter abbreviated to a “prepolymer”), and the prepolymer is powdered and then heated for carrying out solid phase polymerization. Under the solid phase polymerization, the polymerization further proceeds to obtain a liquid crystalline polyester having a high molecular weight.

It is preferred that the liquid crystalline polyester used as the component (A) has a flow-starting temperature of 280° C. or higher, which is calculated by the following method.

Flow-starting temperature: A temperature at a melt viscosity of 4,800 Pa·s (48,000 poise), when a heated melt is extruded through a nozzle, using a capillary tube rheometer equipped with a nozzle of 1 mm in inner diameter and 10 mm in length, by raising temperature at a rate of 4° C./min under the load of 9.8 MPa (100 kg/cm²).

As described above, it is possible to raise the flow-starting temperature of the liquid crystalline polyester to 280° C. or more in a relatively short time, when the solid phase polymerization is employed in the production of the liquid crystalline polyester. Further, when the liquid crystalline polyester having such flow-starting temperature is used as the component (A), the resulting molded article ends up to be highly heat resistant. The flow-starting temperature is an index indicating molecular weight of a liquid crystalline polyester, which is well known in the art (refer to “Synthesis, Molding, Application of Liquid Crystalline Polymers”, pp. 95-105, published by CMC, Jun. 5 in 1987, edited by Naoyuki Koide; using a flow characteristic evaluation device “flow tester CFT-500D” manufactured by Shimadzu Corporation in the present invention as a device for measuring a flow-starting temperature). On the other hand, in order to produce a molded article within a practical temperature range of injection-molding machine, the flow-starting temperature of the liquid crystalline polyester is preferably 420° C. or lower, and more preferably 390° C. or lower.

### <Method for Producing Resin Composition and Molded Article>

The resin composition of the present invention is obtained by mixing the components (A), (B) and (C) according to various known methods.

In the resin composition of the present invention, the amount to be blended is determined such that the content of the component (B) is higher than that of the component (C) by weight. Regarding the amount to be added, it is preferred that the total of the component (B) and component (C) is 150 parts by weight or more based on 100 parts by weight of the component (A), and it is more preferred that the total of the component (B) and component (C) is 180 parts by weight.

Thus, because the content of the component (B) is higher than that of the component (C) by weight, the resulting molded article is able to exhibit high thermal conductivity, while fully decreasing in anisotropy of the thermal conductivity. W_{b}/W_{c} is more preferably 2 or more, and still more preferably 3 or more, when the content of the component (B) is defined as W_{b} (% by weight), and that of the component (C) is defined as W_{c} (% by weight) based on the total amount of the resin composition of the present invention.

The resin composition of the present invention may contain a filler (component (D)) in addition to the component (B) and component (C). Examples of the filler include such as glass fibers, carbon fibers, alumina fibers, wollastonites, glass flakes, silica particles and calcium carbonates, but an inorganic filler is preferred for enhancing the mechanical strength of the resulting molded article, and among these, glass fibers are preferred. When the glass fibers are used as the component (D), the total of the component (B), component (C) and component (D) is preferably 150 parts by weight or more, and more preferably 180 parts by weight or more, based on 100 parts by weight of the component (A).

The resin composition of the present invention may contain conventional additives such as release improvers including fluorine resins or the like; colorants including dyes, pigments or the like; antioxidants; thermal stabilizers; ultraviolet absorbers; antistatic agents; and surfactants as long as the intended objects of the present invention are not adversely affected.

Although the method for producing the resin composition of the present invention is not limited as described above, it is preferred that the components (A), (B) and (C) and optionally used component (D) are mixed using a Henschell mixer or tumbler, and the mixture is melt-kneaded using an extruder. The mixture may be palletized by melt-kneading.

The resin composition thus obtained is subjected to a suitable molding method selected according to the intended shape of the molded article (component). Among these, melt molding is preferred, and injection molding is particularly preferred. The injection molding has advantages such that an article of a complicated shape, especially an article having a thin portion, can be easily produced. The molded article produced by injection molding of the resin composition in the present invention is particularly useful as electric and electronic components, especially as a component requiring thermal conductivity.

In the molded article prepared by melt-molding of the resin composition of the present invention, the thermal conductivity ratio of flow direction (MD direction) to orthogonal direction against the flow direction (TD direction) is extremely low, in the time of injecting a melt of the resin composition (melt resin composition) into a mold upon molding. Specifically, when the thermal conductivity in the MD direction is defined as T_{MD} and that in the TD direction is defined as T_{TD}, T_{MD}/T_{TD} of the molded article obtained is 2 or less. This means that the present resin composition gives a molded article whose thermal conductivity anisotropy is sufficiently decreased, or in other words, whose thermal conductivity is relatively isotropic.

The molded article obtained by molding (such as melt molding, including injection molding) the resin composition of the present invention is excellent in electrical insulating properties such that the molded article may have a specific volume resistance of 1×10¹⁰ Ωm or more when measured at a temperature of 23° C.

### <Use of Molded Article>

The molded article obtained from the resin composition of the present invention is particularly suited for electric and electronic components since the molded article is excellent in thermal conductivity as well as electrical insulating properties. Particularly, it is preferably used as sealants for electronic elements, insulators, reflectors for a display device, casings for storing electronic elements and surface mount components. When the surface mount component is obtained from the resin composition of the present invention, a connecter is preferred among surface mount components. In the electric and electronic components, heat generates when the electric and electronic devices equipped with the components are operated. When heat radiation of the component is not insufficiently performed, erratic behavior arises and reliability may easily decrease. As described above, the molded article obtained from the resin composition of the present invention has such characteristics, which are advantageous to heat radiation, that thermal conductivity is comparatively isotropic. Accordingly, the molded article obtained from the resin composition of the present invention radiates heat efficiently because of its isotropic thermal conductivity when using as electric and electronic components, even if the components have comparatively complicated shapes, and thus realizing a stable operation of the electric and electronic devices equipped with the components.

### EXAMPLES

The present invention is described using the following Examples, but the present invention is not limited to the Examples.

The alumina fine particles as the component (B) used herein are as follows.

Alumina fine particles (Low Soda Alumina fine particles ALM-41-01 manufactured by Sumitomo Chemical Co., Ltd.)

Volume-average particle diameter: 1.7 μm

(It had a bimodal particle size distribution having two maximum values, a maximum value within a range from 1.0 to 2.0 μm in terms of a volume-average particle diameter and a maximum value within a range from 0.2 to 0.4 μm in terms of a volume-average particle diameter.)

BET specific surface area: 1.2 m²/g

The plate-like filler as the component (C) used herein is as follows.

Talc (Talc X50 manufactured by Nippon Talc Co., Ltd.; volume-average particle diameter of the major axis: 17.4 μm, BET specific surface area: 2.64 m²/g)

The glass fiber as the component (D) used herein is as follows.

Glass fiber 1 (chopped glass fiber CS03JAPX-1 manufactured by Asahi Fiberglass Co., Ltd., fiber diameter: 10 μm, fiber length: 3 mm)

### Production Example 1

In a reactor equipped with a stirrer, a torque meter, a nitrogen gas introducing tube, a thermometer and a reflux condenser, 994.5 g (7.2 mol) of parahydroxybenzoic acid, 446.9 g (2.4 mol) of 4,4′-dihydroxybiphenyl, 299.0 g (1.8 mol) of terephthalic acid, 99.7 g (0.6 mol) of isophthalic acid and 1347.6 g (13.2 mol) of acetic anhydride were charged. After fully replacing the atmosphere in the reactor with a nitrogen gas, the temperature inside the reactor was raised to 150° C. under a nitrogen gas atmosphere over 30 minutes, and then the mixture was refluxed for 1 hour while maintaining the same temperature.

The temperature was raised to 320° C. over 2 hours and 50 minutes while distilling off acetic acid produced as by-products and the unreacted acetic anhydride. After completion of the reaction where an increase in torque is recognized, a prepolymer was obtained.

The prepolymer thus obtained was cooled to room temperature, ground by a coarse grinder, and then solid phase polymerization was carried out under a nitrogen atmosphere by raising temperature from room temperature to 250° C. over 1 hour, followed by raising from 250° C. to 285° C. over 5 hours, and maintaining at 285° C. for 3 hours. The flow-starting temperature of the liquid crystalline polyester obtained after the solid phase polymerization was 327° C. The liquid crystalline polyester is referred to as LCP1.

### Examples 1 to 9, Comparative Examples 1 to 4

According to the composition shown in Table 1, LCP1 obtained in Production Example 1, and the above components (B), (C) and (D) were palletized by melt-kneading at 330° C. using a unidirectional twin-screw extruder (PCM-30HS manufactured by Ikegai Iron Works Ltd.). The resulting pellets were injection-molded at a cylinder temperature of 350° C., a mold temperature of 130° C. and at an injection rate of 30 cm³/s using an injection-molding machine (PS40E5ASE-type manufactured by Nissei Plastic Industrial Ltd.). Two kinds of molded articles each having a different shape were obtained and then evaluated.

Molded article 1: 126 mm×12 mm×6 mm;
Molded article 2: ASTM No. 4 dumbbell

With respect to the molded articles thus obtained, specific gravity, thermal conductivity, tensile strength and flexural strength were evaluated. The results are shown in Table 1. The details of the respective evaluations are as follows.

### [Method for Evaluation of Thermal Conductivity]

A 1 mm thick plate-shaped specimen was cut out of the molded article 1 in the direction which is vertical (MD) or parallel (TD) to the major axis direction to obtain a sample for evaluation of thermal conductivity. Thermal diffusivity of the sample was measured using a laser flash thermal constant analyzer (TC-7000 manufactured by Ulvac-Riko, Inc.). Specific heat was measured by DSC (DSC7 manufactured by Perkin Elmer Co., Ltd.) and specific gravity was measured by an automatic specific gravity measuring instrument (ASG-320K manufactured by Kanto Measure Co., Ltd.). The thermal conductivity was calculated by the product of heat diffusivity, specific heat and specific gravity. Anisotropy of thermal conductivity anisotropy was represented by a ratio (T_{MD}/T_{TD}) of the thermal conductivity of MD (T_{MD}) to that of TD (T_{TD}). The larger the ratio, the larger anisotropy of thermal conductivity.

### [Method for Measurement of Tensile Strength and Tensile Elasticity]

Using the molded article 2, measurement was conducted in accordance with ASTM D638.

### [Method for Measurement of Flexural Strength and Flexural Elasticity]

Using the molded article 1, measurement was conducted in accordance with ASTM D790.

TABLE 1

| | | Example 1 | Example 2 | Example 3 | Example 4 | Example 5 | Example 6 | Example 7 |
|---|---|---|---|---|---|---|---|---|
| Part | LCP1 | 100 | 100 | 100 | 100 | 100 | 100 | 100 |
| by | Alumina fine | 140 | 140 | 125 | 100 | 95 | 75 | 130 |
| weight | particles | | | | | | | |
| | Talc | 40 | 20 | 25 | 50 | 35 | 50 | 60 |
| | Glass fiber | | 20 | | | 30 | 25 | |

| Specific gravity | | | 2.30 | 2.29 | 2.21 | 2.15 | 2.15 | 2.10 | 2.28 |
|---|---|---|---|---|---|---|---|---|---|
| Thermal | MD | W/m · k | 4.0 | 3.6 | 2.4 | 2.2 | 2.5 | 1.8 | 3.3 |
| conductivity | TD | | 2.0 | 2.0 | 1.4 | 1.1 | 1.3 | 1.0 | 1.7 |

| Anisotropy of thermal | | 2.0 | 1.8 | 1.7 | 2.0 | 1.9 | 1.7 | 2.0 |
|---|---|---|---|---|---|---|---|---|
| conductivity (T_{MD}/T_{TD}) | | | | | | | | |
| Tensile | MPa | 69 | 85 | 73 | 69 | 81 | 81 | 67 |
| Strength | | | | | | | | |
| Tensile | MPa | 6100 | 6600 | 6700 | 6700 | 6500 | 7900 | 7300 |
| Elasticity | | | | | | | | |
| Flexural | MPa | 87 | 97 | 93 | 96 | 109 | 103 | 87 |
| Strength | | | | | | | | |
| Flexural | MPa | 10700 | 11900 | 10100 | 10500 | 12800 | 12700 | 11900 |
| Elasticity | | | | | | | | |

| | | | | Comparative | Comparative | Comparative | Comparative |
|---|---|---|---|---|---|---|---|
| | | Example 8 | Example 9 | Example 1 | Example 2 | Example 3 | Example 4 |
| Part | LCP1 | 100 | 100 | 100 | 100 | 100 | 100 |
| by | Alumina fine | 130 | 100 | 140 | | 30 | 50 |
| weight | particles | | | | | | |
| | Talc | 30 | 60 | | 140 | 150 | 75 |
| | Glass fiber | 30 | 30 | | | | 25 |

| Specific gravity | | | 2.26 | 2.20 | 2.16 | 1.94 | 2.06 | 2.05 |
|---|---|---|---|---|---|---|---|---|
| Thermal | MD | W/m · k | 3.1 | 1.9 | 3.1 | 2.6 | 3.0 | 2.6 |
| conductivity | TD | | 1.7 | 1.0 | 1.4 | 1.0 | 1.0 | 1.1 |

| Anisotropy of thermal | | 1.8 | 1.9 | 2.2 | 2.6 | 2.9 | 2.4 |
|---|---|---|---|---|---|---|---|
| conductivity (T_{MD}/T_{TD}) | | | | | | | |
| Tensile | MPa | 81 | 78 | 91 | 59 | 47 | 81 |
| Strength | | | | | | | |
| Tensile | MPa | 8200 | 8100 | 5500 | 4500 | 5200 | 7700 |
| Elasticity | | | | | | | |
| Flexural | MPa | 94 | 97 | 115 | 88 | 75 | 100 |
| Strength | | | | | | | |
| Flexural | MPa | 12900 | 13800 | 9500 | 9600 | 10500 | 13200 |
| Elasticity | | | | | | | |

It was found that the molded articles obtained from the resin composition obtained in Examples 1 to 9 have high thermal conductivity at 1 w/m·K in both MD and TD directions, and sufficiently small anisotropy of thermal conductivity in which a ratio of the thermal conductivity in the MD direction to that in the TD direction (T_{MD}/T_{TD}) is 2 or less. In contrast, T_{MD}/T_{TD} exceeds 2 in the molded articles obtained from a resin composition containing no plate-like filler (Comparative Example 1), a resin composition containing no alumina fine particles (Comparative Example 2) and resin compositions in which the mass content of alumina fine particles is less than that of talc (Comparative Examples 2 to 4), and thus it is clear that anisotropy of the thermal conductivity is large.

### Example 10

A molded article was obtained in the same manner as in Example 1 except for using a different mold with a different size and shape from those of the mold used in Example 1. As a result, a molded article having a size of 64 mm×64 mm×3 mm was obtained using the same resin composition as in Example 1.

The specific volume resistance of the molded article was measured in accordance with ASTM D257 using a digital ampere meter for measuring an electrical-insulating or fine current (model: DSM-8104, manufactured by Toa DKK Co., Ltd.) at a temperature of about 23° C. The specific volume resistance of the molded article was 6×10¹² Ωm.

### Example 11

A molded article was obtained in the same manner as in Example 10 except for using the resin composition used in Example 2 rather than the resin composition used in Example 1. The specific volume resistance of the molded article was 2×10¹² Ωm.

### Examples 12 to 18

Molded articles were obtained in the same manner as in Example 10 except for using the resin composition used in Examples 3 to 9, respectively, rather than the resin composition used in Example 1. The values of specific volume resistance of the molded articles were all 1×10¹⁰ Ωm or more.

What is claimed is:

1. A resin composition comprising
(A) a thermoplastic resin,
(B) alumina fine particles and
(C) a plate-like filler comprising an electrical insulating material,
wherein the resin composition contains the component (B) in the larger amount than the amount of the component (C) and has a specific volume resistance of 1×10¹⁰ Ωm or more.

2. The resin composition according to claim 1, wherein the resin composition contains 150 parts by weight or more of the component (B) and the component (C) in total on the basis of 100 parts by weight of the component (A).

3. The resin composition according to claim 1, wherein the component (B) comprises alumina fine particles having a BET specific surface area of from 1 to 5 m²/g.

4. The resin composition according to claim 1, wherein the component (B) comprises alumina fine particles having a bimodal particle size distribution obtained by laser diffraction scattering method.

5. The resin composition according to claim 4, wherein the bimodal particle size distribution has a maximum value within a range of from 1 to 5 μm and a maximum value within a range of from 0.1 to 1 μm, both values being in terms of volume-average particle diameter.

6. The resin composition according to claim 1, wherein the component (C) comprises talc having a BET specific surface area of from 1 to 5 m²/g.

7. The resin composition according to claim 6, wherein the talc has an average particle diameter of 15 μm or larger.

8. The resin composition according to claim 1, further comprising a glass fiber as a component (D).

9. The resin composition according to claim 8, wherein the resin composition contains 150 parts by weight or more of the component (B), the component (C) and the component (D) in total on the basis of 100 parts by weight of the component (A).

10. The resin composition according to claim 1, wherein the component (A) comprises a liquid crystalline polyester.

11. The resin composition according to claim 10, wherein the liquid crystalline polyester has a flow-starting temperature of from 280° C. or higher.

12. The resin composition according to claim 10, wherein the liquid crystalline polyester has:
a structural unit derived from parahydroxybenzoic acid and/or a structural unit derived from 2-hydroxy-6-naphthoic acid as a structural unit derived from an aromatic hydroxycarboxilic acid,
a structural unit derived from hydroquinone and/or a structural unit derived from 4,4′-dihydroxybiphenyl as a structural unit derived from an aromatic diol, and
at least one structural unit derived from an aromatic dicarboxylic acid selected from the group consisting of structural units derived from terephthalic acid, isophthalic acid and 2,6-naphthalene dicarboxylic acid, and wherein
the total amount of the structural units derived from the aromatic hydroxycarboxylic acid is in the range of from 30 to 80% by mol based on the amount of the entire structural units,
the total amount of the structural units derived from the aromatic diol is in the range of from 10 to 35% by mol based on the total of the entire structural units, and
the total amount of the structural units derived from the aromatic dicarboxylic acid is in the range of from 10 to 35% by mol based on the amount of the entire structural units.

13. A molded article obtainable by melt-molding the resin composition according to claim 1.

14. The molded article according to claim 13, wherein the molded article is a molded article with a thermal conductivity in the MD direction of 2 times or less of thermal conductivity in the TD direction.

15. The molded article according to claim 13, which is used as electric and electronic components.

16. The molded article according to claim 15, wherein the electric and electronic components are selected from the group consisting of sealants for electronic elements, insulators, reflectors for display devices, casings for storing electronic elements and surface mount components.
